(19) United States
(12) Patent Application Publication
(10) Pub. No.: US 2012/0145863 A1
(43) Pub. Date: Jun. 14, 2012

(54) SUPPORTING STRUCTURE FOR PORTABLE ELECTRONIC PRODUCTS

(76) Inventor: HSIN-LIANG LIN, KEELUNG CITY (TW)

(21) Appl. No.: 12/967,465

(22) Filed: Dec. 14, 2010

(51) Int. Cl. F16M 13/00; F16B 2/02

(52) U.S. Cl. 248/316.1; 248/309.1

(57) ABSTRACT

A supporting structure for portable electronic products is disclosed. The supporting structure includes a main body and a first supporting unit. The first supporting unit has a first finger portion and a second finger portion. The first supporting unit is disposed on one end of the main body. The first finger portion corresponds to the second finger portion. The supporting structure allows the user to easily and stably hold a portable electronic product.

### BACKGROUND OF THE INVENTION

1. Field of the Invention

The present invention relates to an ergonomic supporting structure, and more particularly to a supporting structure having an ergonomic finger module for holding a portable electronic product, such as a cell phone, a personal digital assistant (PDA), or an electronic book.

2. Description of Related Art

Thanks to the advance of technology, electronic accessories in the past have become daily indispensable items today. Electronic products with touch screen functionality, such as PDAs, cell phones, e-books and tablet PCs, are also becoming the mainstream electronic products as the trend needs. These electronic products offer the functions of wireless internet access, image capture and video and other entertainment, and the user used to hold them for long time enjoying the convenience of new technologies while suffering muscle soreness and pain due to the overdue muscle tension of the thumb-index web part caused by inappropriate way to hold the electronic products or long-term holding them. Furthermore, damages may be caused when the users accidentally drop the electronic products from their hands. Stains, lipid or finger prints from user's hands may be left on the electronic products, needing to wipe the electronic products frequently.

Therefore, there is a need of a design which overcomes the above disadvantages.

### SUMMARY OF THE INVENTION

One object of the present invention is to provide a supporting structure for portable electronic products. The supporting structure for portable electronic products includes a main body and a first supporting unit. The first supporting unit includes a first finger portion and a second finger portion. The first finger portion corresponds to the second finger portion

Another object of the invention is to provide a supporting structure for portable electronic products, including a protective covering and a first supporting unit integrally formed with the protective covering. The first supporting unit includes a first finger portion and a second finger portion in a manner that the first finger portion corresponds to the second finger portion.

In light of the above, the supporting structure for portable electronic products advantageously allows the user to easily hold the electronic product. Therefore it is labor saving and has good stability. Furthermore, the user would not directly contact the electronic product, preventing any stain, lipid or finger prints left on the electronic product, enhancing the convenience in use.

In order to further the understanding regarding the present invention, the following embodiments are provided along with illustrations to facilitate the disclosure of the present invention. However, the appended drawings are merely shown for exemplary purposes, rather than being used to restrict the scope of the instant disclosure.

### BRIEF DESCRIPTION OF THE DRAWINGS

FIG. 1A is a perspective view of a supporting structure of portable electronic product in assembly according to a first embodiment of the present invention;

FIG. 1B is a perspective view of a supporting structure of portable electronic product in assembly according to a second embodiment the present invention;

FIG. 2A is a perspective view of a supporting structure of portable electronic product in assembly according to a third embodiment the present invention;

FIG. 2B is a perspective view of a supporting structure of portable electronic product in assembly according to a fourth embodiment the present invention;

FIG. 3 is a perspective view of a supporting structure of portable electronic product in assembly according to a fifth embodiment the present invention;

FIG. 4 is a perspective view of a supporting structure of portable electronic product in assembly according to a sixth embodiment the present invention; and

FIG. 5 is a perspective view of a supporting structure of portable electronic product in assembly according to a seventh embodiment the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

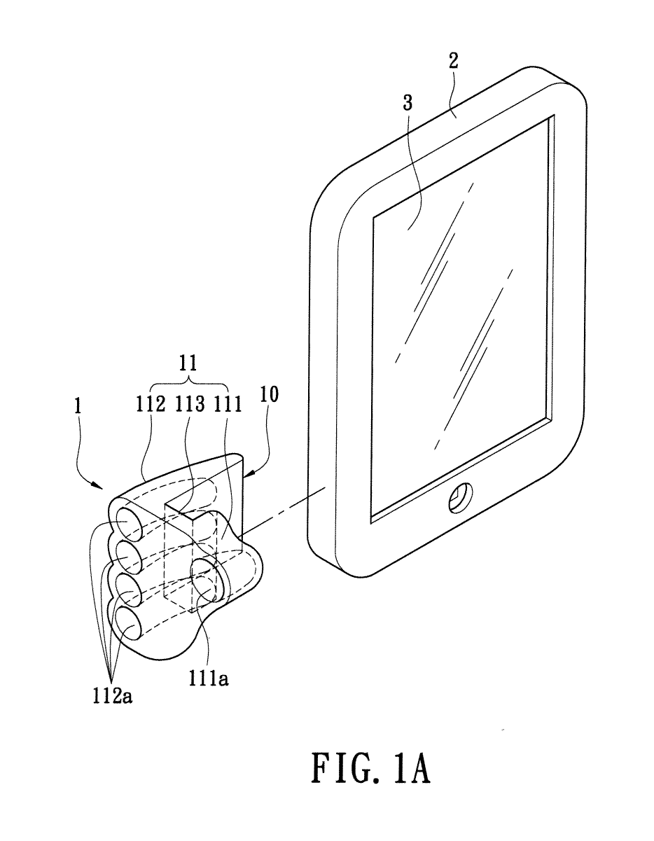

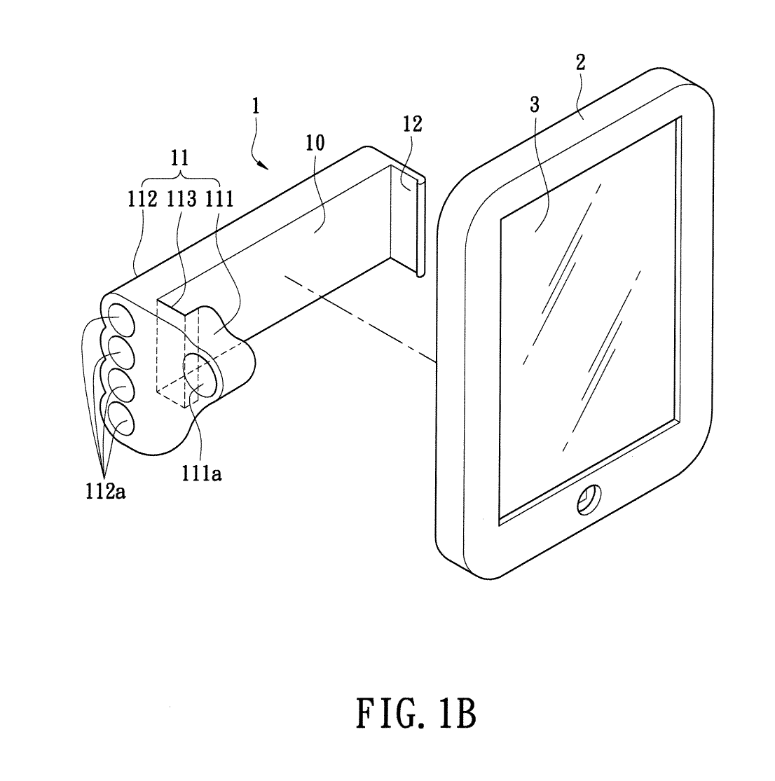

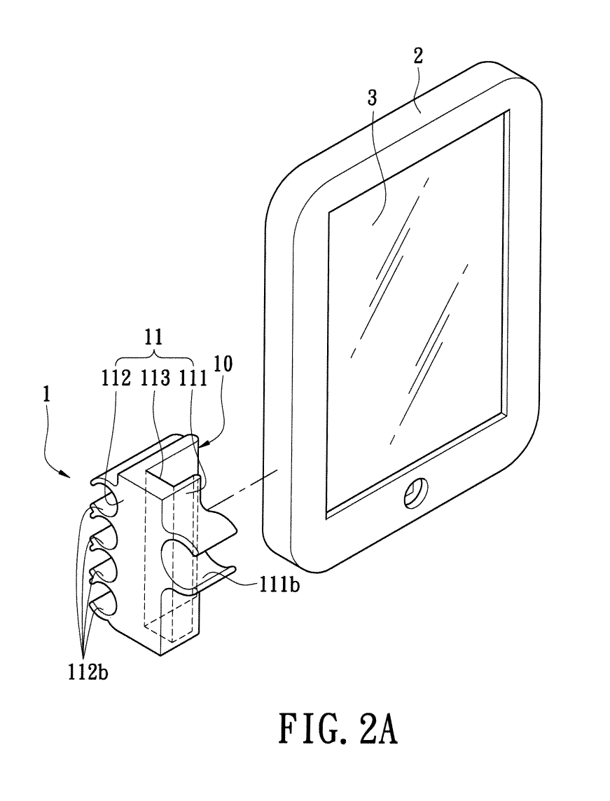

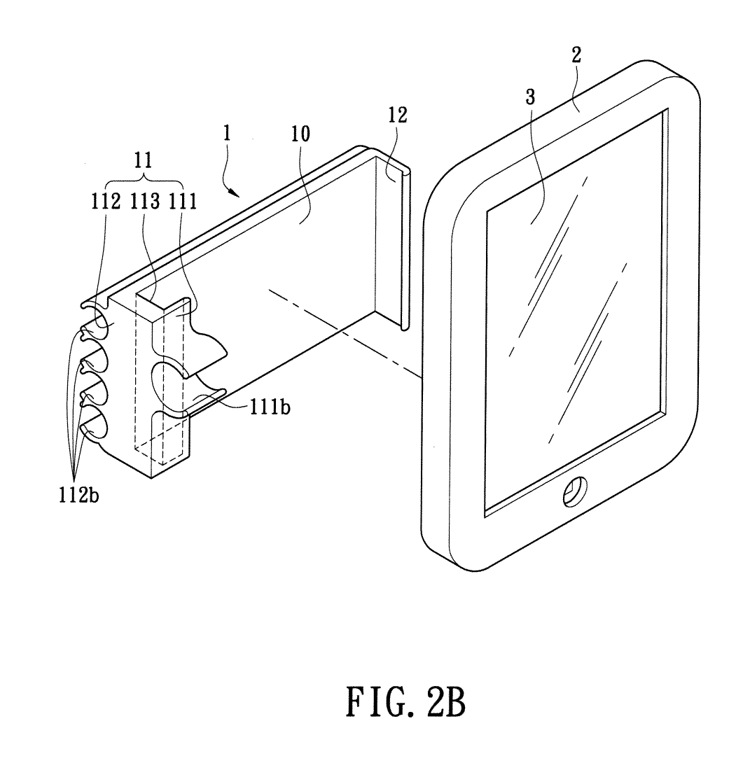

Referring to FIG. 1A through FIG. 2B, a supporting structure 1 for a portable electronic product according to the invention can be disposed on a protective covering 2 of the portable electronic product 3 or directly assembled onto the electronic product 3. The supporting structure 1 of the invention includes a main body 10, and a first supporting unit 11 disposed on one end of the main body. The first supporting unit 11 further has a first finger portion 111 and a second finger portion 112 in a manner that the first finger portion 111 corresponds to the second finger portion 112. The first finger portion 111 has one first opening 111a on at least one side thereof and the second finger portion 112 has at least one second opening 112a on at least one side thereof.

The superior adhesion of the supporting structure 1 of the invention to the protective covering 2 of the electronic product 3 or the electronic product 3 itself favors the user to easily hold the electronic product 3 or the covering 2 by means of holding the supporting structure 1, preventing the muscle soreness or pain caused by inappropriate way to apply force for the user's hands and/or long-term holding of the electronic product 3. Therefore, the supporting structure 1 of the invention has advantages of easy holding and stability. Furthermore, the supporting structure 1 of the invention supports the electronic product 3 so that the electronic product 3 would not be touched directly, preventing any stains, lipid or finger prints from the user onto the electronic product 3 and thus enhancing the convenience in use.

FIG. 1A shows a supporting structure 1 for a portable electronic product according to a first embodiment of the invention. A main body 10 of a supporting structure 1 is made integrally with the first supporting unit 11, and therefore the supporting structure 1 of the invention does not need any assembling process, significantly saving the manufacturing cost and marketing cost. The first supporting unit 11 is integrally disposed on one end of the main body 10. The first finger portion 111 and the second finger portion 112 are correspondingly disposed on the first supporting unit 11. Specifically, the second finger portion 112 is bent backward from the first finger portion 111. There is a positioning portion 113 between the second finger portion 112 and the first finger portion 111. The positioning portion 113 is connected to the first supporting unit 11 by glue or sewing. The positioning portion 113 can be, but not limited to, a Velcro, a magnet, or a reinforced protrusion. The number of the positioning portion 113 can be one or more. The above positioning portion 113 is useful and durable because of its resistance to long-term friction. The positioning portion 113 allows the supporting structure 1 of the invention be preferably secured onto the electronic product 3. In other words, the user uses the supporting structure 1 of the invention to firmly hold the electronic product 3 so that the electronic product 3 does not tend to fall down from the user's hand and any damage caused by accidentally dropping the electronic product 3 can be avoided.

In this embodiment, both of the first finger portion 111 and the second finger portion 112 are of finger cots structures. The first finger portion 111 has a first opening 111a and the second finger portion 112 has at least one second opening 112a, as shown in FIG. 1A. The second finger portion 112 has four second openings 112a. But in other cases, the second finger portion 112 can have one, two or three second openings 112a. The first opening 111a goes through the first finger portion 111, and the second opening 112a goes through the second finger portion 112. In other words, each end of the first opening 111a and the second opening 112a can be open. The first finger portion 111 and the second finger portion 112 can be, but not limited to, polyester yarn, fully drawn yarn (FDY), polyester/nylon composite wire, cationic polyester yarn, nylon yarn, cotton fibers, polyester fibers, microfiber synthetic leather yarn, natural leather yarn, or a mixture of at least two selected from above. The first finger portion 111 and the second finger portion 112 in this embodiment have eye-shaped openings, i.e., the first opening 111a and the second opening 112a, and respectively have breathable structures which function to drain out the heat from the user's hands to reduce the wetting and sticking feeling for the user. Furthermore, the above finger cots structures is designed for the user to put the thumb correspondingly into the first opening 111a, while the index finger, middle finger, ring finger and the little finger correspondingly into the second openings 112a so that when the user holds the electronic product 3 via the supporting structure 1 of the invention, the weight of the electronic product 3 can be uniformly distributed over the whole supporting structure 1. Compared to directly holding the electronic product 3 the user can more easily hold the electronic product 3.

FIG. 1B shows a supporting structure 1 for a portable electronic product according to a second embodiment of the invention. This embodiment is the same as the first embodiment, except that the supporting structure 1 of the invention includes a first supporting unit 11 disposed on one end of the main body 10, and a second supporting unit 12 disposed on the other end of the main body 10. The second supporting unit 12 is bent from the main body 10. The second supporting unit 12 can be, but not limited to, a fastening mechanism, an embedding mechanism, or a hooking mechanism. With the use of the positioning portion 113 and the second supporting unit 12, the supporting structure 1 of the invention is preferably secured onto the electronic product 3. Furthermore, with the configuration that the second opening 112a goes through the second finger portion 112 and extends toward the second supporting unit 12, the main body 10 has significant structural strength and thickness for the protective covering 2 of the electronic product 3 to stand firmly by the support of the main body 10 so that the electronic product 3 is held at a view angle in favor of the user's sight.

FIG. 2A shows a supporting structure 1 of a portable electronic product according to a third embodiment of the invention. This embodiment is the same as the first embodiment, except that the first finger portion 111 and the second finger portion 112 of the first supporting unit 11 are of finger buckling structures. The first finger portion 111 has one first finger buckle 111b and the second finger portion 112 has at least one finger buckle 112b. As shown in FIG. 2A, the second finger portion 112 has four second finger buckles 112b, even though one, two or three second finger buckles 112b can be used alternatively. The first finger buckle 111b and the second finger buckle 112b are U-shaped. The above finger buckling structures are designed for the user's thumb to be correspondingly fastened to the first finger buckle 111b while the index finger, the middle finger, the ring finger, and the little finger correspondingly fastened to the second finger buckles 112b.

FIG. 2B shows a supporting structure 1 for a portable electronic product according to a fourth embodiment of the invention. This embodiment is the same as the second embodiment, except that the first finger portion 111 and the second finger portion 112 of the first supporting unit 11 are of finger buckling structures, and the first finger buckle 111b of the first finger portion 111 and the at least one second finger buckle 112b of the second finger portion 112 are U-shaped. The at least one second finger buckle 112b of the second finger portion 112 extend toward the second supporting unit 12 so that the main body 10 of the supporting structure 1 has a significant structural strength and thickness. When the user does not use the supporting structure 1 of the invention to hold the electronic product 3, the supporting structure 1 of the invention can be a holder for the electronic product 3 in any position and at any angle.

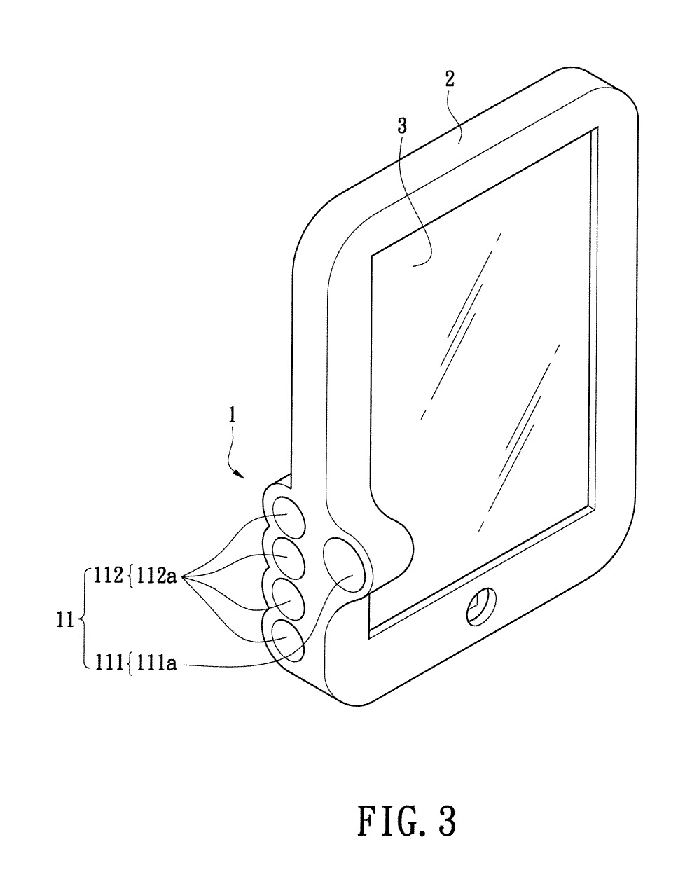

FIG. 3 shows a supporting structure 1 for a portable electronic product according to a fifth embodiment of the invention. This embodiment is the same as the second embodiment, except that the first supporting unit 11 of the supporting structure 1 of the invention is formed integrally with the protective covering 2. In other words, the supporting structure 1 includes the protective covering 2 and the first supporting unit 11 integrally formed with the protective covering 2. The first supporting unit 11 includes the first finger portion 111 and the second finger portion 112 corresponding to the first finger portion 111. Therefore, the supporting structure 1 of the invention does not need any assembling processes, greatly reducing the marketing cost and the manufacturing cost due to saving time and labor in batch assembly. Furthermore, the supporting structure 1 in this embodiment can be also used as a holder for the electronic product 3, so that the electronic product 3 can be placed or stored with improved efficiency.

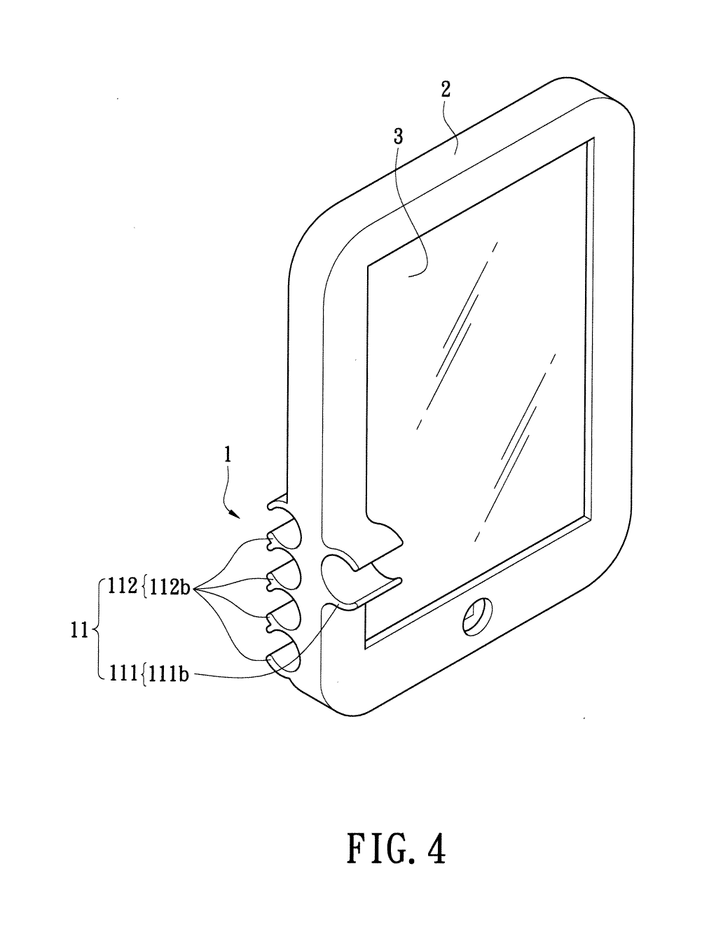

FIG. 4 shows a supporting structure 1 for a portable electronic product according to a sixth embodiment of the invention. This embodiment is the same as the fourth embodiment, except that the first supporting unit 1 of the supporting structure 1 for the portable electronic product is formed integrally with the protective covering 2. The supporting structure 1 in this embodiment can be also used as a holder for the electronic product 3 to stand firmly.

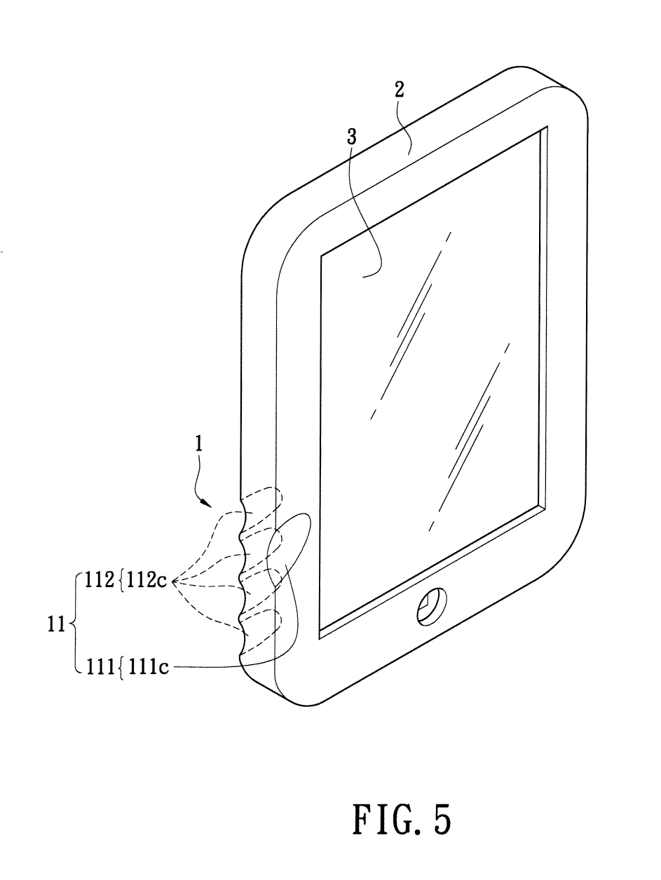

FIG. 5 shows a supporting structure for a portable electronic product according to a seventh embodiment of the invention. The first supporting unit 11 of the supporting structure 1 can be formed integrally with the protective covering 2. The first supporting unit 11 includes a first finger portion 111 and a second finger portion 112, both of which are of finger impression structures. The first finger portion 111 has one recessed first pressing portion 111c, while the second finger portion 112 has at least one recessed second pressing portion 112c. As shown in FIG. 5, the second finger portion 112 has four second pressing portions 112c, but one, two or three pressing portions 112c can be used alternatively. The above finger impression structures are designed for the user's thumb to be correspondingly placed onto the first pressing portion 111c while the index finger, the middle finger, the ring finger and the little finger are correspondingly placed onto the pressing portions 112c. This embodiment is particularly suitable for the electronic product 3 having small size and light weight.

In light of the above, the supporting structure 1 of the invention offers the following advantages.

First, the superior adhesion between the supporting structure 1 and the protective covering 2 of the electronic product 3 or the electronic product 3 itself allows the user easily to hold the electronic product 3 or the protective covering 2 by means of the supporting structure 1, preventing the muscle soreness or pain caused by inappropriate way to apply force for the user's hands and caused by long-term holding of the electronic product 3. Therefore, the supporting structure 1 of the invention has advantages of easy holding and stability.

Second, the supporting structure 1 of the invention is of integrally-formed structure, without any need of assembling processes. Therefore, the manufacturing cost and marketing cost are greatly reduced.

Thirdly, the positioning portion 113 and the second supporting unit 12 of the supporting structure 1 are useful and durable because of their resistance to long-term friction. The user uses the supporting structure 1 of the invention to firmly hold the electronic product 3 so that the electronic product 3 does not tend to fall down from the user's hand and any damage caused by accidentally dropping the electronic product 3 can be avoided.

Next, since the electronic product 3 would not be touched directly, any stains, lipid or finger prints from the user onto the electronic product 3 can be prevented by means of using the supporting structure 1 and thus the convenience in use can be enhanced.

In addition, when the first supporting unit 11 of the supporting structure 1 is of finger cots structure which has eye-shaped opening and a breathable structure, the heat from the user's hands can be drained out to reduce the wetting and sticking feeling for the user and increase the comfort.

Furthermore, with the combination of the supporting structure 1 and the protective covering 2, the electronic product 3 can stand firmly by means of being held directly by the main body 10 in any positions and at any angle in favor of the user's sight.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A supporting structure for portable electronic products, comprising:
a main body; and
a first supporting unit disposed on one end of the main body; the first supporting unit having a first finger portion and a second finger portion; wherein the second finger portion corresponds to the first finger portion.

2. The supporting structure as claimed in claim 1, wherein the supporting structure further comprising a second supporting unit disposed on the other end of the main body, the second supporting unit is curved inwardly from the main body.

3. The supporting structure as claimed in claim 1, wherein the supporting structure is integrally formed.

4. The supporting structure as claimed in claim 2, wherein the supporting structure is integrally formed.

5. The supporting structure as claimed in claim 1, wherein the second finger portion is bent backward from the first finger portion.

6. The supporting structure as claimed in claim 2, wherein the second finger portion is bent backward from the first finger portion.

7. The supporting structure as claimed in claim 1, wherein the first finger portion and the second finger portion are of finger cots structures, wherein the finger cots structures are made of polyester yarn, fully drawn yarn (FDY), polyester/nylon composite wire, cationic polyester yarn, nylon yarn, cotton fiber, polyester fiber, microfiber synthetic leather yarn, natural leather yarn, or a mixture of at least two selected from above.

8. The supporting structure as claimed in claim 2, wherein the first finger portion and the second finger portion are of finger cots structures, wherein the finger cots structures are made of polyester yarn, fully drawn yarn (FDY), polyester/nylon composite wire, cationic polyester yarn, nylon yarn, cotton fiber, polyester fiber, microfiber synthetic leather yarn, natural leather yarn, or a mixture of at least two selected from above.

9. The supporting structure as claimed in claim 7, wherein the first finger portion has one first opening on at least one side thereof and the second finger portion has at least one second opening on at least one side thereof.

10. The supporting structure as claimed in claim 8, wherein the first finger portion has one first opening on at least one side thereof and the second finger portion has at least one second opening on at least one side thereof.

11. The supporting structure as claimed in claim 9, wherein the first opening of the first finger portion goes through the first finger portion, the at least one second opening of the second finger portion goes through the second finger portion.

12. The supporting structure as claimed in claim 10, wherein the first opening of the first finger portion goes through the first finger portion, the at least one second opening of the second finger portion goes through the second finger portion.

13. The supporting structure as claimed in claim 1, wherein the first finger portion and the second finger portion are of finger buckling structures.

14. The supporting structure as claimed in claim 2, wherein the first finger portion and the second finger portion are of finger buckling structures.

15. The supporting structure as claimed in claim 13, wherein the first finger portion has one first finger buckle and the second finger portion has at least one second finger buckle.

16. The supporting structure as claimed in claim 14, wherein the first finger portion has one first finger buckle and the second finger portion has at least one second finger buckle.

17. The supporting structure as claimed in claim 15, wherein the first finger buckle of the first finger portion is a U-shaped buckle, and the at least one second finger buckle of the second finger portion is a U-shaped buckle.

18. The supporting structure as claimed in claim 16, wherein the first finger buckle of the first finger portion is a U-shaped buckle, and the at least one second finger buckle of the second finger portion is a U-shaped buckle.

19. The supporting structure as claimed in claim 2, wherein the second supporting unit is a fastening mechanism, an embedding mechanism, or a hooking mechanism.

20. The supporting structure as claimed in claim 1, wherein at least one positioning portion is disposed between the first finger portion and the second finger portion, and the positioning portion is a Velcro, a magnet, or a reinforced protrusion.

21. The supporting structure as claimed in claim 2, wherein at least one positioning portion is disposed between the first finger portion and the second finger portion, and the positioning portion is a Velcro, a magnet, or a reinforced protrusion.

22. A supporting structure for portable electronic products, comprising:
a protective covering; and
a first supporting unit integrally formed with the protective covering, the first supporting unit having a first finger portion and a second finger portion, wherein the second finger portion corresponds to the first finger portion.

23. The supporting structure as claimed in claim 22, wherein the first finger portion and the second finger portion are finger cots structures.

24. The supporting structure as claimed in claim 23, wherein the first finger portion has one first opening on at least one side thereof and the second finger portion has at least one second opening on at least one side thereof.

25. The supporting structure as claimed in claim 24, wherein the first opening of the first finger portion goes through the first finger portion, the at least one second opening of the second finger portion goes through the second finger portion.

26. The supporting structure as claimed in claim 22, wherein the first finger portion and the second finger portion are of finger buckling structures.

27. The supporting structure as claimed in claim 26, wherein the first finger portion has one first finger buckle and the second finger portion has at least one second finger buckle.

28. The supporting structure as claimed in claim 27, wherein the first finger buckle of the first finger portion is a U-shaped buckle, and the at least one second finger buckle of the second finger portion is a U-shaped buckle.

29. The supporting structure as claimed in claim 22, wherein the first finger portion and the second finger portion are of finger impression structures.

30. The supporting structure as claimed in claim 29, wherein the first finger portion of the first supporting unit has one first pressing portion and the second finger portion of the first supporting unit has at least one second pressing portion.
